(19) United States
(12) Patent Application Publication
(10) Pub. No.: US 2005/0015540 A1
(43) Pub. Date: Jan. 20, 2005

(54) Auto-executable portable data storage device and the method of auto-execution thereof

(76) Inventors: Hung-Chou Tsai, Jiji Jen (TW); Chi-Tung Chang, Wugu Township (TW); Shih-Hsieng Yang, Junghe City (TW)

Correspondence Address: RABIN & BERDO, P.C., Suite 500, 1101 14th Street, N.W., Washington, DC, 20005, US

(21) Appl. No.: 10/621,392

(22) Filed: Jul. 18, 2003

(51) Int. Cl. G06F 12/00

(52) U.S. Cl. 711/103; 711/115

(57) ABSTRACT

A portable data storage device is characterized in having an internal file and a start program separately pre-recorded in predetermined segments on a flash memory of the device, an encryption mechanism for protecting the device against arbitrary access, and auto-execution ability like a compact disk. With these arrangements, it is ensured the start program is automatically executed without any user operation to play the internal file each time the portable data storage device is used. And, the internal file is effectively protected from deletion, unauthorized copy, or theft.

### FIELD OF THE INVENTION

The present invention relates to a portable data storage device, and more particularly to a portable data storage device that is automatically executable in a method of automatic execution thereof.

### BACKGROUND OF THE INVENTION

In response to the quick development and popularization of many advanced electronic apparatuses, such as computers, digital cameras, MP3 players, and various mobile devices, as well as varied types of information and transmission manners thereof, there is developed a variety of data storage devices (or storage media) to satisfy different demands.

Data storage devices developed in early stages may be generally divided into two types. The first type of data storage device is an electronic solid-state memory, such as read-only memory (ROM) and random access memory (RAM). This type of storage device is usually built in a computer. Unless it is non-erasable, it must be constantly supplied with power to keep the stored data. Thus, the first type of storage device does not meet the purpose of being conveniently portable. The second type of data storage device is a surface-based data storage device. Magnetic disks and compact disks are typical examples of the surface-based data storage devices. For this type of data storage device, data stored thereon must be accessed through a mechanical driving mechanism, such as a disk drive or a CD-ROM, and a memory capacity thereof is limited by a surface area thereof. In the case of a hard disk that has a relatively large memory capacity, a motor and a magnetic head are required to operate the hard disk. Other disadvantages of the surface-based data storage devices include having big volume, being non-resistant to shock, etc. Therefore, the second type of storage device does not meet the purpose of being conveniently portable, either.

In summary, a portable data storage device or storage medium should generally meet the following conditions:

1. Non-volatile: A main purpose of the portable data storage device is to allow free transferring or copying of stored data from an electronic apparatus to another different electronic apparatus, such as from a computer system to another computer system, from a digital camera to a computer system, or from a computer system to a personal digital assistant (PDA). Therefore, the ability of keeping stored data even when a power interruption occurs is a required feature of the portable data storage device.

2. Shock-resistant: Since the portable data storage device is often moved or carried in non-anticipated environments, it is very important for it to be highly shock-resistant and vibration-resistant. And, since movements of mechanical access, such as in the case of a hard disk drive, is very sensitive to shock and vibration, it is particularly important to reduce as much as possible movements of mechanical access to avoid the possibility of access error or machine failure.

3. High storage density: In consideration of good portability of and limited space available on a mobile device, such as the PDA, the portable data storage device must well take advantage of any and all space and be thin, short, light, and compact. Thus, it is very important for the portable data storage device to have high storage density.

4. Low power consumption: The portable data storage device is frequently used to transfer data between a computer system and a mobile device. It is known the mobile device is powered with batteries that have limited capacity while there are two major elements on the mobile device, namely, a processor and a display screen, that are highly power consumptive. Under this condition, there is only very limited power available for other peripherals of the mobile device. Thus, it is also very important for the portable data storage device to have low power consumption.

The solid-state non-volatile memory among the existing semiconductor memory components may be generally divided into several types, including mask read-only memory (MASK ROM), one-time programmable read-only memory (OTPROM), erasable programmable read-only memory (EPROM), electrically erasable programmable read-only memory (EEPROM), and flash memory. Wherein, the flash memory fully meets all the above-listed conditions and is therefore widely employed in the portable data storage device.

The flash memory may be differently designed to provide different memory arrays. Currently, there are several types of memory arrays available for use, including NOR, NAND, DINOR, and AND types. On the other hand, the flash memory may be functionally divided into two types, namely, code flash and data flash. The code flash is mainly configured with the NOR-type flash and generally used on products that do not require a large memory capacity, such as the BIOS (basic input and output system) for PC (personal computers), mobile phones, PDA, etc. On the other hand, the data flash is usually configured with the NAND-type flash and has a memory capacity normally larger than 16 MB, and is therefore suitable for storing and reading a large quantity of data, and using on digital cameras, MP3 players, computer systems, and various types of mobile devices to serve as a data storage device (or storage medium)

The following are some commercially available products of data flash being used as a portable data storage device or storage medium:

1. Multimedia Card (MMC): it is normally used on digital cameras, smart phones, MP3 players, etc.

2. Compact Flash Card (CF Card): it is normally used on digital cameras, palm-top computers, MP3 players, PDA, etc.

3. Smart Media Card: it is normally used on digital cameras, palm-top computers, MP3 players, PDA, etc.

4. PC-ATA Flash Card (PC Card): it is normally used on notebook computers and electronic interpreters.

5. Memory Stick: it is mainly used on products manufactured by SONY.

6. USB Flash Disk/USB Mass Storage Device: An example of this product is disclosed in Taiwanese New Utility Model Patent Publication No. 531028. It is normally used on computer systems or other electronic apparatuses having a USB (universal serial bus) port.

The above-mentioned various types of portable data storage devices may be sold independently, but are also frequently sold along with different processing apparatuses, such as notebook computers, desktop computers, palm-top computers, digital cameras, MP3 players, PDA, etc. With the popularization of more USB devices and wireless modular products, these portable data storage devices have become a new trend in the gift market and are frequently used as a means to represent a business or promote various products.

However, the currently available portable data storage devices do not have an auto-executing feature like a compact disk (CD). When a conventional portable data storage device is coupled with an electronic apparatus, such as a computer, a user has to select folders stored in the portable data storage device one by one to load, execute, play, or file them sequentially. And, any user may alter, or even copy file data stored on the portable data storage device. Moreover, the coupled electronic apparatus would not particularly distinguish in, for example, its file manager the portable data storage device from other magnetic disks. Therefore, users tend to confuse these storage devices with one another.

No matter the portable data storage devices are sold as merchandise or manufactured as gifts to publicize a business or promote a product, it is desirable to include some internal files in the storage device to briefly introduce the manufacturer and/or the products thereof. These internal files are different from the graphic advertisement provided on an outer appearance of the product. Moreover, it would be a great help in impressing users with the business product brand or the generality of the product and the good after service thereof if the internal files introducing the business and the products are automatically executed each time the portable data storage device is used. It would be more preferable if the auto-executing internal files in the portable data storage device were protected against deletion to ensure the auto-execution thereof. And, it would be most preferable if the internal files were hidden in a segment of the memory that could not be opened by users to prevent the internal files from unauthorized copy or theft.

Therefore, it is tried by the inventor to develop a portable data storage device having the auto-executing feature as a compact disk, so that an existed processing unit of an electronic apparatus, such as a computer, may automatically execute a start program via a controller of the device to play an internal file, which may be pre-recorded in a hidden segment of a flash memory of the storage device and encrypted to protect the internal file against unauthorized access. Whereby, when the portable data storage device is coupled with an electronic apparatus, it will be automatically executed to load the internal start program and play the internal file completely without any user operation. Moreover, the internal file and the start program could not be deleted, altered, or copied without a password provided by the manufacture. That is, it is possible to ensure the automatic execution and play of the internal file each time the portable data storage device is used, and to effectively prevent the internal file from deletion and unauthorized copy or theft. Moreover, the start program may include an icon instruction and an icon file representing the portable data storage device, so that the icon is automatically displayed in the operating system of the coupled electronic apparatus to represent the portable data storage device and distinguish the device from other magnetic disks to avoid confusing users.

### SUMMARY OF THE INVENTION

It is therefore a primary object of the present invention to provide a portable data storage device having the auto-executing function to play an internal file, and a method for automatically executing the internal file on the portable data storage device.

Another object of the present invention is to provide a portable data storage device and a method of auto-execution thereof, so that an internal file in the device could not be deleted, altered, or copied without a password provided by the manufacturer of the device.

A further object of the present invention is to provide a portable data storage device and a method of auto-execution thereof, so that an internal file in the device could not be read or opened without a password provided by the manufacturer of the device.

A still further object of the present invention is to provide a portable data storage device and a method of auto-execution thereof, so that an icon representing the device may be displayed on an electronic apparatus coupled with the device to distinguish the device from other magnetic disks.

To achieve the above and other objects, the present invention provides a portable data storage device adapted to couple with an electronic apparatus for the electronic apparatus to automatically execute and play an internal file stored in the portable data storage device. The portable data storage device mainly includes an interface unit for coupling with a processing unit of the electronic apparatus; a flash memory into and from which data can be written and read; and a control unit located between and coupled with the interface unit and the flash memory to control input and output of data into and from the flash memory.

The portable data storage device is characterized in that the flash memory includes a predetermined segment particularly divided to set as a compact-disk (CD) device and to store the internal file, that the CD device includes a start program, and that the processing unit of the coupled electronic apparatus is caused to detect via the control unit a virtual CD-ROM in the CD device, and thereby locates the start program to automatically execute and play the internal file.

Wherein, the start program includes an auto-execution file, such as Autorun.inf, and an application, such as Setup.exe, having driving mechanisms for playing the internal file. The driving mechanisms of the application sequentially include: copying the internal file from a predetermined segment to another segment of the flash memory, or to a storage unit of the electronic apparatus; starting a corresponding program to play the copied internal file; and deleting the copied internal file after completion of playing of the copied internal file.

The above-mentioned auto-execution file may further include an icon instruction and an icon file representing the portable data storage device, so that an operating system of the coupled electronic apparatus automatically displays a designated icon to represent the portable data storage device and to distinguish the latter from other magnetic disks.

The flash memory of the portable data storage device is not limited to have only one predetermined segment, but may be divided into first, second, and third segments. The first segment is set as a CD device having a start program, the second segment is a general read/write segment, and the third segment is used to store the internal file. The processing unit of the coupled electronic apparatus is caused to detect via the control unit the virtual CD-ROM in the CD device, and thereby locates the start program to automatically execute and play the internal file.

The third segment has a password pre-recorded therein, and the control unit is adapted to decrypt and compare an input password with the pre-recorded password to determine whether data may be read from or written into the third segment, so that the third segment is a hidden segment that could not be read by users. Therefore, the internal file could not be deleted, altered, copied, read, or opened without the password provided by the manufacturer of the device.

The present invention also provides a method for automatically executing the above-described portable data storage device. The method includes the following steps:
coupling the interface unit of the portable data storage device with the processing unit of the electronic apparatus, so as to cause the processing unit to detect the virtual CD-ROM in the CD device; and
causing the processing unit of the electronic apparatus to locate via the control unit of the portable data storage device a designated start program in the virtual CD-ROM, and to automatically execute and play the internal file.

The above step of executing the start program further includes steps of executing an auto-execution file and an application having driving mechanisms for playing the internal file.

Wherein, the step of executing the application having driving mechanisms for playing the internal file further includes the steps of:
copying the internal file from the predetermined segment to another segment of the flash memory or to the storage unit of the electronic apparatus;
starting a corresponding program to play the copied internal file; and
deleting the copied internal file after completion of playing of the copied internal file.

And, the step of executing the auto-execution file further includes the step of executing an icon instruction to cause an operating system of the coupled electronic apparatus to automatically display a designated icon representing the portable data storage device.

The method may further include the step of setting the third segment of the flash memory as a hidden segment that could not be read by users, so that the internal file could not be deleted, altered, copied, read or opened without the password provided by the manufacturer.

With the auto-executable portable data storage device of the present invention and the method for auto-execution thereof, a non-volatile and shock-resistant portable data storage device having high storage density and low power consumption may be provided to solve the problems existed in the conventional portable data storage devices, including unable to automatically execute and play the internal file, and tending to confuse with other magnetic disks in the operating system. Thus, the portable data storage device of the present invention has the function of being automatically executed to play the internal file thereof, ensuring the safety of the internal file, and clearly distinguishing itself from other magnetic disks in the operating system of the coupled electronic apparatus.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the auto-executable portable storage device of the present invention.

### DETAILED DESCRIPTION OF THE PREFERRED EMBODIMENTS

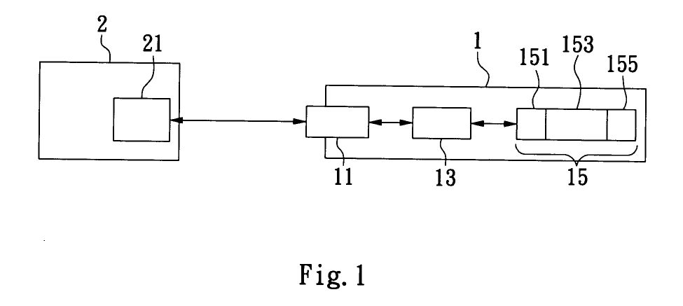

Please refer to FIG. 1 that is a block diagram showing a portable data storage device 1 according to the present invention. As shown, the portable data storage device 1 mainly includes an interface unit 11, a control unit 13, and a flash memory 15. The portable data storage device 1 of the present invention is configured to couple with an electronic apparatus, such as a computer, so that the electronic apparatus may automatically execute the files and/or programs stored in the portable data storage device 1 without the need of changing any structure of the electronic apparatus. To highlight the characteristics of the present invention, the following description emphasizes only on portions of the portable data storage device 1 that are most important to achieve the objects of the present invention, and descriptions of other portions are omitted without detriment to the wholeness of the present invention.

The portable data storage device 1 may be, for example, a universal serial bus (USB) flash disk or a USB mass storage device. However, it is understood that the portable data storage device of the present invention is not limited to the above-mentioned USB flash disk or USB mass storage device, but may otherwise be a multi-media card (MMC), a compact flash card (CF Card), a smart media card, a PC-ATA flash card (PC Card), a Memory Stick, or any other flash-memory-based portable data storage device or element.

As can be seen from FIG. 1, the interface unit 11 is selectively coupled with a processing unit 21 of an electronic apparatus 2, so that the electronic apparatus 2 may display, read and/or write files stored in the portable data storage device 1. In the illustrated embodiment of the present invention, since the portable data storage device 1 may be, for example, a USB flash disk or a USB mass storage device, the interface unit 11 may be, for example, a freely extendable connector adapted to connect to the electronic apparatus 2. Meanwhile, in the case the electronic apparatus 2 is, for example, a computer, the interface unit 11 may otherwise be a USB plug for coupling with a corresponding USB socket on the electronic apparatus 2. However, the interface unit 11 may be differently configured depending on a structure of the portable data storage device 1 or of the electronic apparatus 2 with which the interface unit 11 is coupled.

The control unit 13 is located between the interface unit 11 and the flash memory 15 to couple with them, so as to control the input and output of data to and from the portable data storage device 1. The control unit 13 may be, for example, a micro controller to include a read-only memory (ROM) for storing a control program, so as to do necessary management and control of the flash memory 15. Although the illustrated embodiment is described with a micro controller as the control unit 13, it is understood the control unit 13 may also be, for example, a firmware or other suitable element. Since the micro controller or the firmware is known in their actions and technical principles, they are not discussed in details herein.

The flash memory 15 has at least one file and/or program stored therein, and is coupled with the control unit 13 for the latter to read and write data of the stored file and/or program. As can be seen from FIG. 1, the flash memory 15 in the illustrated embodiment is divided by way of segmentation into a first segment 151, a second segment 153, and a third segment 155.

The first segment 151 may be set as a compact disk (CD) device, in which all source codes for a virtual CD-ROM and a start program are included. The start program includes an auto-execution file, such as Autorun.inf, and an application, such as Setup.exe, having driving mechanisms for playing an internal file. The second segment 153 is a general read/write segment allowing users to freely store or read data. The third segment 155 is used to store an internal file, such as an image file, a picture file, or a word data file, to be added on by the manufacturer to briefly introduce company profile and product. A password may be pre-recorded in the third segment 155. The control unit 13 decrypts and compares an input password with the pre-recorded password to determine whether data may be read from or written into the third segment 155. In this manner, the third segment 155 constitutes a hidden segment that is not readable by users. In other words, the internal file stored in the third segment 155 could not be deleted, altered, copied, read, or opened without the manufacturer-provided password.

The main usage of the first segment 151 that is set as a CD device is to provide all source codes for a virtual CD-ROM, so that the firmware of the control unit 13 emulates and restores these source codes to the processing unit 21 of the electronic apparatus 2, which uses an operating system, such as Windows 98/ME/2000/XP, developed by Microsoft. In this manner, a virtual CD-ROM existed in the portable data storage device 1 may be created, and the processing unit 21 is caused to identify the virtual CD-ROM as a real CD-ROM and automatically reads the auto-execution file, for example, Autorun.inf, under a root directory thereof.

Since the contents and coding skills for all the source codes of the virtual CD-ROM are known, and not a part of the characteristics of the present invention, they are not discussed herein.

The above-mentioned auto-execution file, such as Autorun.inf, is used to locate and execute an application at a designated position, such as Setup.exe, in order to start the application to run the following driving mechanisms:

1. Copying the internal file from the third segment 155 to the second segment 153 (or to a storage unit, such as a RAM, a hard disk, or the like of the electronic apparatus 2);

2. Causing the processing unit 21 of the electronic apparatus 2 to start a corresponding program from the operating system, so as to play the internal file in the second segment 153; and

3. Deleting the internal file from the second segment 153 (or from the storage unit, such as the RAM or hard disk, of the electronic apparatus 2) after completion of playing the internal file.

In addition to execute an application, such as Setup.exe, the above-mentioned auto-execution file, such as Autorun.inf, may further include an icon instruction and an icon file representing the portable data storage device, so as to automatically display the designated icon in the operating system of the electronic apparatus 2 to represent the portable data storage device 1. For instance, it is possible to additionally record some files, such as Company.ico, Company.htm, etc., in the first segment 151 at designated positions thereof, and to add the following instructions in the auto-execution file, such as Autorun.inf:
Open=explorer.exe Company.htm
Icon=Company.ico

In conclusion, the above arrangements have provided a unique auto-executable portable data storage device, which may be, for example, a USB flash disk or a USB mass storage device. And, a method of automatically executing the portable data storage device includes the following steps:

1. Couple the interface unit 11, which may be, for example, a USB plug, of the portable data storage device 1 with the processing unit 21, which may be, for example, a USB socket, of the electronic apparatus 2;

2. The processing unit 21, which uses supports from, for example, Windows developed by Microsoft, automatically determines the type of the USB device of the interface unit 11, and then emulates via the firmware of the control unit 13 all source codes for the virtual CD-ROM in the CD device set in the first segment 151 and restores them to the processing unit 21, so as to create a virtual CD-ROM existed in the portable data storage device 1 for the processing unit 21 to identify the virtual CD-ROM as a real CD-ROM and automatically read and analyze the auto-execution file, for example, Autorun.inf, under a root directory thereof;

3. The processing unit 21 analyzes the auto-execution file, and then automatically uses the designated icon file, such as the instruction of icon=Company.ico, to automatically display the designated icon in the processing unit 21 (operating system) of the electronic apparatus 2, so as to represent the portable data storage device 1;

4. Meanwhile, from the position designated by the auto-execution file, the processing unit 21 locates and executes the application having the driving mechanisms for playing the internal files;

5. Execute the application to copy the internal file from the third segment 155 to the second segment 153 or to the storage unit of the electronic apparatus 2, such as a RAM or a hard disk;

6. Execute the application for the processing unit 21 of the electronic apparatus 2 to start a corresponding program from the operating system, so as to play the internal file in the second segment 153 or in the storage unit of the electronic apparatus 2, such as a RAM or a hard disk; and

7. Delete the internal file from the second segment 153 or from the storage unit of the electronic apparatus 2, such as the RAM or hard disk, after completion of playing the internal file.

The above-mentioned internal file is not limited to an image file, a picture file, or a word data file introducing the company profile and products, but may otherwise be a protection program, a service program, a variety of programs, drivers for these programs, an auto-installation program, such as Install.bat, or combinations thereof.

In the event the internal file includes or is a protection program, the protection program will be automatically executed when the portable data storage device is coupled with (or plugged in) the processing unit (or system) of the electronic apparatus. The protection program detects whether a password has been specified. If yes, an interface (that is, a window) is displayed to request the user to enter the correct password. When the entered password is correct, the user is permitted to access the portable data storage device. And, when the entered password is incorrect, the user is prohibited from accessing any data from the device.

Or, in the event the internal file includes or is a service program, the service program will be automatically executed when the portable data storage device is coupled with (or plugged in) the processing unit (or system) of the electronic apparatus, so that the service program is stored in the storage unit of a system. When a user operates or uses any file and requests for services, the service program provides a corresponding function to meet the users' request. With this new mechanism of providing an auto-executing service program, it is not necessary to run an installation program. For most software and hardware manufacturers, this is doubtless an important breakthrough in the computer-related field.

With the auto-executing portable data storage device of the present invention and the method of auto-execution thereof, it is not only possible to maintain the non-volatility, shock resistance, high storage density, and low power consumption of the portable data storage device, but also solve many problems existed in the conventional portable data storage devices, such as failing to automatically execute and play the internal file, easy to become confused with other disks in the operating system. The portable data storage device of the present invention is therefore improved and highly practical for use due to the following reasons:

1. It automatically executes to play the internal file, and a user may conveniently use the device without the need of selecting or operating or installing additional programs.

2. It automatically displays the icon representing the portable data storage device plugged in the electronic apparatus to advantageously distinguish the device from other different disk drives.

3. It may be conveniently carried and is a plug and play device.

4. The related CD device, the start program, and the internal file would not be undesirably deleted, because they are recorded or stored in read-only or encrypted segments.

The present invention has been described with a preferred embodiment thereof and it is understood that many changes and modifications in the described embodiment can be carried out without departing from the scope and the spirit of the invention as defined by the appended claims.

1. A portable data storage device adapted to couple with an electronic apparatus for said electronic apparatus to automatically execute and play an internal file stored in said portable data storage device, comprising:
an interface unit for coupling with a processing unit of said electronic apparatus;
a flash memory into and from which data can be written and read; and
a control unit located between and coupled with said interface unit and said flash memory to control input and output of data into and from said flash memory;
said portable data storage device being characterized in that said flash memory includes at least one predetermined segment particularly divided to set as a compact-disk (CD) device and to store said internal file; said CD device including a start program adapted to cause said processing unit of said electronic apparatus to detect via said control unit a virtual CD-ROM in said CD device, and thereby locate said start program to automatically execute and play said internal file.

2. The portable data storage device as claimed in claim 1, wherein said interface unit includes a universal serial bus (USB) plug for coupling with a corresponding USB socket on said electronic apparatus.

3. The portable data storage device as claimed in claim 1, wherein said start program includes an auto-execution file and an application having driving mechanisms for playing said internal file.

4. The portable data storage device as claimed in claim 3, wherein said driving mechanisms of said application sequentially include:
copying said internal file from said predetermined segment to another segment of said flash memory;
starting a corresponding program to play said copied internal file; and
deleting said copied internal file after completion of playing of said copied internal file.

5. The portable data storage device as claimed in claim 3, wherein said driving mechanisms of said application sequentially include:
copying said internal file from said predetermined segment of said flash memory to a storage unit of said electronic apparatus;
starting a corresponding program to play said copied internal file; and
deleting said copied internal file after completion of playing of said copied internal file.

6. The portable data storage device as claimed in claim 3, wherein said auto-execution file further includes an icon instruction and an icon file representing said portable data storage device, so as to automatically display a designated icon in an operating system of said electronic apparatus to represent said portable data storage device.

7. The portable data storage device as claimed in claim 1, wherein said control unit comprises a micro controller.

8. The portable data storage device as claimed in claim 7, wherein said micro controller includes a read-only memory for recording a control program thereon.

9. The portable data storage device as claimed in claim 1, wherein said internal file is selected from a group consisting of image files, picture files, word data files, protection programs, service programs, other programs and drivers thereof, and auto installation programs, and combinations of any two or more items thereof.

10. A portable data storage device adapted to couple with an electronic apparatus for said electronic apparatus to automatically execute and play an internal file stored in said portable data storage device, comprising:
an interface unit for coupling with a processing unit of said electronic apparatus;
a flash memory into and from which data can be written and read; and
a control unit located between and coupled with said interface unit and said flash memory to control input and output of data into and from said flash memory;
said portable data storage device being characterized in that said flash memory being divided into a first, a second, and a third segment; said first segment being set as a CD device having a start program, said second segment being a general read/write segment, and said third segment being used to store said internal file; and said processing unit of said electronic apparatus being caused to detect via said control unit a virtual CD-ROM in said CD device, and thereby locates said start program to automatically execute and play said internal file.

11. The portable data storage device as claimed in claim 10, wherein said interface unit includes a universal serial bus (USB) plug for coupling with a corresponding USB socket on said electronic apparatus.

12. The portable data storage device as claimed in claim 10, wherein said start program includes an auto-execution file and an application having driving mechanisms for playing said internal file.

13. The portable data storage device as claimed in claim 12, wherein said driving mechanisms of said application sequentially include:
copying said internal file from said third segment to said second segment of said flash memory;
starting a corresponding program to play said internal file in said second segment; and
deleting said internal file in said second segment after completion of playing of said internal file.

14. The portable data storage device as claimed in claim 12, wherein said driving mechanisms of said application sequentially include:
copying said internal file from said third segment of said flash memory to a storage unit of said electronic apparatus;
starting a corresponding program to play said internal file stored in said storage unit; and
deleting said internal file stored in said storage unit after completion of playing of said internal file.

15. The portable data storage device as claimed in claim 12, wherein said auto-execution file further includes an icon instruction and an icon file representing said portable data storage device, so as to automatically display a designated icon in an operating system of said electronic apparatus to represent said portable data storage device.

16. The portable data storage device as claimed in claim 10, wherein said control unit comprises a micro controller.

17. The portable data storage device as claimed in claim 16, wherein said micro controller includes a read-only memory for recording a control program thereon.

18. The portable data storage device as claimed in claim 10, wherein said third segment of said flash memory is a hidden segment that could not be read by users.

19. The portable data storage device as claimed in claim 18, wherein said hidden segment has a password pre-recorded therein, and said control unit is adapted to decrypt and compare an input password with said pre-recorded password to determine whether data may be read from or written into said hidden segment.

20. The portable data storage device as claimed in claim 10, wherein said internal file is selected from a group consisting of image files, picture files, word data files, protection programs, service programs, other programs and drivers thereof, and auto installation programs, and combinations of any two or more items thereof.

21. A method of automatic execution of a portable data storage device, comprising the following steps:
coupling an interface unit of said portable data storage device with a processing unit of an electronic apparatus, so as to cause said processing unit to detect a virtual CD-ROM in a CD device set in a predetermined segment of a flash memory of said portable data storage device; and
causing said processing unit of said electronic apparatus to locate via a control unit of said portable data storage device a designated start program in said virtual CD-ROM, and to automatically execute and play an internal file stored in another predetermined segment of said flash memory of said portable data storage device.

22. The method of automatic execution of a portable data storage device as claimed in claim 21, further comprising steps of executing an auto-execution file and an application having driving mechanisms for playing said internal file that are included in said start program.

23. The method of automatic execution of a portable data storage device as claimed in claim 22, wherein said step of executing said application having driving mechanisms for playing said internal file further includes the steps of:
copying said internal file from said predetermined segment to another segment of said flash memory;
starting a corresponding program to play said copied internal file; and
deleting said copied internal file after completion of playing of said copied internal file.

24. The method of automatic execution of a portable data storage device as claimed in claim 22, wherein said step of executing said application having driving mechanisms for playing said internal file includes the steps of:
copying said internal file from said predetermined segment of said flash memory to a storage unit of said electronic apparatus;
starting a corresponding program to play said copied internal file; and
deleting said copied internal file after completion of playing of said copied internal file.

25. The method of automatic execution of a portable data storage device as claimed in claim 22, wherein said step of executing said auto-execution file further includes the step of executing an icon instruction to cause an operating system of said electronic apparatus to automatically display a designated icon representing said portable data storage device.

26. A method of automatic execution of a portable data storage device, comprising the following steps:
coupling an interface unit of said portable data storage device with a processing unit of an electronic apparatus, so as to cause said processing unit to detect a virtual CD-ROM in a CD device set in a first segment of a flash memory of said portable data storage device; and
causing said processing unit of said electronic apparatus to locate via a control unit of said portable data storage device a designated start program in said virtual CD-ROM, and to automatically execute and play an internal file stored in a third segment of said flash memory of said portable data storage device.

27. The method of automatic execution of a portable data storage device as claimed in claim 26, further comprising steps of executing an auto-execution file and an application having driving mechanisms for playing said internal file that are included in said start program.

28. The method of automatic execution of a portable data storage device as claimed in claim 27, wherein said step of executing said application having driving mechanisms for playing said internal file further includes the steps of:
copying said internal file from said third segment to a second segment of said flash memory; said second segment being a general read/write segment;
starting a corresponding program to play said internal file in said second segment; and
deleting said internal file in said second segment after completion of playing of said internal file.

29. The method of automatic execution of a portable data storage device as claimed in claim 27, wherein said step of executing said application having driving mechanisms for playing said internal file further the steps of:
copying said internal file from said third segment of said flash memory to a storage unit of said electronic apparatus;
starting a corresponding program to play said internal file stored in said storage unit; and
deleting said internal file stored in said storage unit after completion of playing of said internal file.

30. The method of automatic execution of a portable data storage device as claimed in claim 27, wherein said step of executing said auto-execution file further includes the step of executing an icon instruction to cause an operating system of said electronic apparatus to automatically display a designated icon representing said portable data storage device.

31. The method of automatic execution of a portable data storage device as claimed in claim 26, further comprising the step of setting said third segment of said flash memory as a hidden segment that could not be read by users.
